(19) United States
(12) Patent Application Publication
(10) Pub. No.: US 2026/0171052 A1
(43) Pub. Date: Jun. 18, 2026

(54) METHOD FOR PROCESSING INFORMATION, INFORMATION PROCESSING SYSTEM, AND RECORDING MEDIUM

(71) Applicant: YAMAHA CORPORATION, Hamamatsu-shi (JP)

(72) Inventors: Shigeru KAI, Yokohama-shi (JP); Yuta OGURA, Hamamatsu-shi (JP); Junya MATSUSHITA, Hamamatsu-shi (JP)

(21) Appl. No.: 19/417,833

(22) Filed: Dec. 12, 2025

(30) Foreign Application Priority Data
Dec. 18, 2024 (JP) 2024-221336

(51) Int. Cl. G10H 1/00; G06F 3/01

(52) U.S. Cl. CPC G10H 1/0008; G06F 3/011; G10H 2220/391; G10H 2220/395

(57) ABSTRACT

A method for processing information, the method includes: identifying a position and an orientation of a musical instrument based on a first detection signal output from a first sensor configured to detect the position and the orientation of the musical instrument, the musical instrument being a real musical instrument used by a real user; identifying a playing operation of the real musical instrument made by the real user based on a second detection signal output from a second sensor that detects the playing operation of the real musical instrument; controlling, based on the identified position and the identified orientation of the real musical instrument, a position and an orientation of a virtual musical instrument used by a virtual user; and controlling, based on the identified playing operation of the real musical instrument made by the real user, a playing operation of the virtual musical instrument made by the virtual user.

### CROSS REFERENCE TO RELATED APPLICATION

This Application is based on and claims priority from Japanese Patent Application No. 2024-221336, which was filed on Dec. 18, 2024, and the entire contents of which are incorporated herein by reference.

### BACKGROUND

### Technical Field

This disclosure relates to a technique for controlling videos.

A musical instrument equipped with a variety of sensors to detect movement of a user of the musical instrument has been proposed. For example, Japanese Patent Application Laid-Open Publication No. 2022-151642 discloses a stringed musical instrument equipped with a sensor. The sensor outputs a detection signal that imparts acoustic effects to a signal representative of string vibrations.

A scenario is envisioned in which movement of a virtual user in a virtual space is controlled based on movement of a real user in a real space. In this scenario, movement of the real user playing a real musical instrument in the real space is replicated by the virtual user playing a virtual musical instrument in the virtual space. However, a configuration in which only output from a sensor of the real musical instrument in the real space is provided to the virtual player and the virtual instrument, it is not possible to adequately replicate movement of the real user in movement of the virtual user.

### SUMMARY

In view of the above circumstances, an object of one aspect of this disclosure is to accurately replicate movement of a real user playing a real musical instrument in a real space in video data representative of movement of a virtual user playing a virtual musical instrument in a virtual space.

A method for processing information, according to an aspect of this disclosure, includes: identifying a position and an orientation of a musical instrument based on a first detection signal output from a first sensor configured to detect the position and the orientation of the musical instrument, the musical instrument being a real musical instrument used by a real user; identifying a playing operation of the real musical instrument made by the real user based on a second detection signal output from a second sensor that detects the playing operation of the real musical instrument; controlling, based on the identified position and the identified orientation of the real musical instrument, a position and an orientation of a virtual musical instrument used by a virtual user; and controlling, based on the identified playing operation of the real musical instrument made by the real user, a playing operation of the virtual musical instrument made by the virtual user.

An information processing system, according to an aspect of this disclosure, includes: at least one memory that stores a program; and at least one processor that executes the program to: identify a position and an orientation of a musical instrument based on a first detection signal output from a first sensor configured to detect the position and the orientation of the musical instrument, the musical instrument being a real musical instrument used by a real user; identify a playing operation of the real musical instrument made by the real user based on a second detection signal output from a second sensor that detects the playing operation of the real musical instrument; control, based on the identified position and the identified orientation of the real musical instrument, a position and an orientation of a virtual musical instrument used by a virtual user; and control, based on the identified playing operation of the real musical instrument made by the real user, a playing operation of the virtual musical instrument made by the virtual user.

A non-transitory computer-readable recording medium, according to an aspect of this disclosure, is a recording medium storing a program executable by at least one processor of a computer to perform a processing information method. The processing information method includes: identifying a position and an orientation of a musical instrument based on a first detection signal output from a first sensor configured to detect the position and the orientation of the musical instrument, the musical instrument being a real musical instrument used by a real user; identifying a playing operation of the real musical instrument made by the real user based on a second detection signal output from a second sensor that detects the playing operation of the real musical instrument; controlling, based on the identified position and the identified orientation of the real musical instrument, a position and an orientation of a virtual musical instrument used by a virtual user; and controlling, based on the identified playing operation of the real musical instrument made by the real user, a playing operation of the virtual musical instrument made by the virtual user.

### BRIEF DESCRIPTION OF THE DRAWINGS

FIG. 1 is a block diagram of a video control system according to a first embodiment.

FIG. 2 is a block diagram of a wind instrument.

FIG. 3 is a schematic diagram of a virtual playing video.

FIG. 4 is a block diagram of an information processing system.

FIG. 5 shows a relationship between a real user and a real wind instrument, and a virtual user and a virtual wind instrument.

FIG. 6 is a flowchart of a video control process.

FIG. 7 is a flowchart of first control process according to a second embodiment.

FIG. 8 is a flowchart of second control process according to a third embodiment.

FIG. 9 is a block diagram of a video control system according to a fourth embodiment.

FIG. 10 is a flowchart of second control process according to the fourth embodiment.

FIG. 11 is a correction flowchart according to a fifth embodiment.

FIG. 12 is a flowchart of a video control process according to a modification.

### DESCRIPTION OF THE EMBODIMENTS

### A: First Embodiment

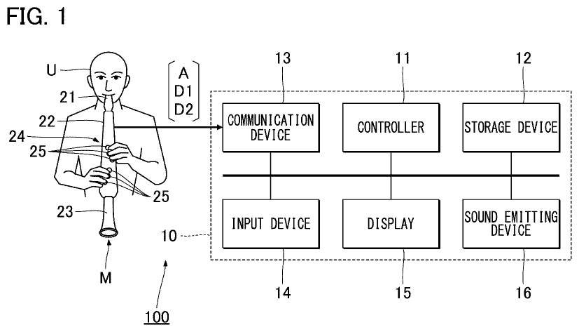

FIG. 1 is a block diagram of a video control system 100 according to a first embodiment. The video control system 100 includes a wind instrument M and an information processing system 10. The wind instrument M is a real musical wind instrument played by a real user U of the video control system 100. The video control system 100 is a computer system that generates video data Z representative of playing of the real wind instrument M by the real user U.

The wind instrument M is an electronic wind musical instrument with an appearance that resembles an acoustic wind musical instrument, such as a saxophone or a clarinet. The wind instrument M includes a mouthpiece (blowing section) 21, a main body 22, and a bell (sound output section) 23. The mouthpiece 21 includes an opening through which the user U blows when playing the wind instrument M. The bell 23 expands in a curved shape towards its distal end, and outputs sound. The main body 22 is provided between the mouthpiece 21 and the bell 23. The main body 22 includes an operation section 24 that is operated by the user U. The operation section 24 includes a plurality of keys (operators) 25 that are operated by the user U to designate a pitch when playing the wind instrument M.

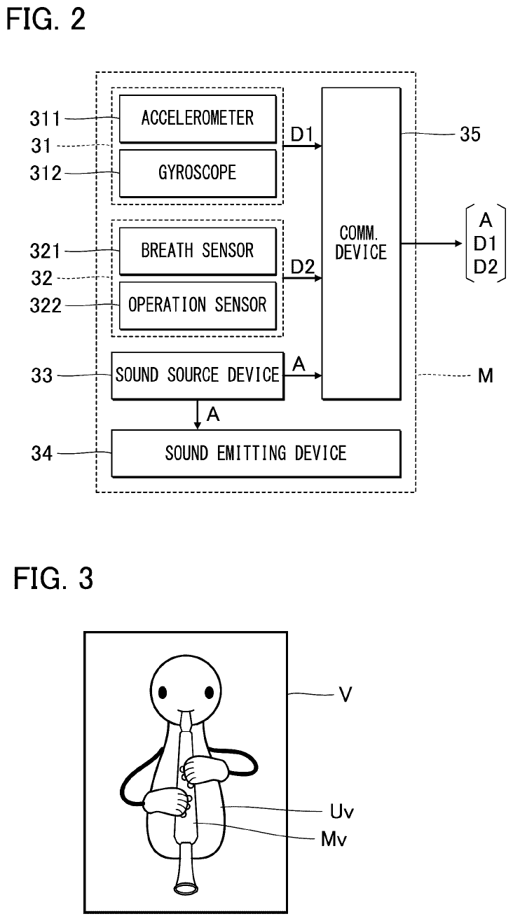

FIG. 2 is a block diagram of a wind instrument M. The wind instrument M includes a first sensor 31, a second sensor 32, a sound source device 33, a sound emitting device 34, and a communication device 35. The sound source device 33 generates an audio signal A in accordance with a playing operation of the user U. Specifically, when the user U blows into the mouthpiece 21, the sound source device 33 generates an audio signal A representative of a sound having a pitch designated by a key operated by the user U in the operation section 24. The sound emitting device 34 is a speaker that emits sound (a soundwave) corresponding to the audio signal A. The sound emitted by the sound emitting device 34 is transmitted via the bell 23.

The first sensor 31 detects a position and orientation of the wind instrument M in a real space. Specifically, the first sensor 31 includes an accelerometer 311 that detects an acceleration along each of three orthogonal axes, and a gyroscope 312 that detects an angular velocity of rotation around each of the three orthogonal axes (yaw, pitch, and roll). The first sensor 31 generates a first detection signal D1 that corresponds to the position and orientation of the wind instrument M. Specifically, the first detection signal D1 represents as follows: acceleration along the three orthogonal axes detected by the accelerometer 311, and angular velocities around the axes detected by the gyroscope 312.

The second sensor 32 detects movement of the user U playing the wind instrument M. Specifically, the second sensor 32 detects playing operations made by the user U. The second sensor 32 includes a breath sensor 321 and an operation sensor 322. The breath sensor 321 detects breath of the user exhaled into the mouthpiece 21. Examples of the breath sensor 321 include a pressure sensor that measures a pressure of exhaled air from the user U, and a flow rate sensor that measures an air flow rate from the user U. The operation sensor 322 detects input made by the user U to the operation section 24. The operation sensor 322 may comprise a key sensor that detects input of the user U to each of the keys 25.

The second sensor 32 generates a second detection signal D2 based on a movement of the user U relative to the wind instrument M, namely, a playing operation made by the user U. Specifically, the second detection signal D2 represents both the blowing characteristics (e.g., air pressure) detected by the breath sensor 321 and input operations (e.g., respective ones of the keys 25 operated by the user U) detected by the operation sensor 322. As will be clear from this description, in the first embodiment, the acts of blowing into the mouthpiece 21 and operating the operation section 24 are each detected by the second sensor 32 as a playing operation of the wind instrument M carried out by the user U.

The communication device 35 communicates with the information processing system 10. Specifically, the communication device 35 transmits to the information processing system 10, each of the audio signal A generated by the sound source device 33, the first detection signal D1 generated by the first sensor 31, and the second detection signal D2 generated by the second sensor 32.

As shown in FIG. 1, the information processing system 10 includes a controller 11, a storage device 12, a communication device 13, an input device 14, a display 15, and a sound emitting device 16. The information processing system 10 may be implemented using an information device, such as a smartphone, tablet computer, or personal computer. The information processing system 10 may comprise a single device or may comprise a combination of two or more devices.

The controller 11 comprises one or more processors that control each element of the information processing system 10. Examples of the one or more processors include a CPU (Central Processing Unit), a GPU (Graphics Processing Unit), an SPU (Sound Processing Unit), a DSP (Digital Signal Processor), an FPGA (Field Programmable Gate Array), and an ASIC (Application Specific Integrated Circuit).

The storage device 12 comprises one or more memories that store programs for execution by the controller 11, and a variety of types of data used by the controller 11. Examples of the one or more memories include a recording medium, such as a magnetic recording medium and a semiconductor recording medium. The storage device 12 may be configured as a combination of two or more types of recording media. Further, the storage device 12 may be a portable recording medium that is attachable to and detachable from the information processing system 10, or may be a cloud storage that is written to or read from by the controller 11 via a network.

The communication device 13 communicates with the wind instrument M. Specifically, the communication device 13 receives from the wind instrument M, the audio signal A, the first detection signal D1, and the second detection signal D2. Communication between the wind instrument M and the information processing system 10 may be either wired or wireless communication.

The input device 14 receives input from the user U. The input device 14 may comprise keys (buttons) or a touch panel that detects touch inputs. The display 15 displays a variety of images under control of the controller 11. The display 15 may comprise a display panel, such as a liquid crystal panel or an organic electroluminescence panel.

The sound emitting device 16 emits sound (sound waves) under control of the controller 11. Examples of the sound emitting device 16 include a loudspeaker and earphones. The sound emitted from the sound emitting device 16 corresponds to the audio signal A.

The controller 11 generates video data Z representative of playing by the user U of the wind instrument M. Hereinafter, a video represented by the video data Z is referred to as “virtual playing video V.” The video data Z generated by the controller 11 is stored in the storage device 12. FIG. 3 is a schematic diagram of the virtual playing video V. As shown in FIG. 3, the virtual playing video V is displayed on the display 15 under control of the controller 11.

The virtual playing video V represents a virtual player (hereinafter, “virtual user Uv”) playing a virtual wind instrument Mv in a three-dimensional virtual space. The virtual space is generated by computations carried out by the controller 11.

The virtual user Uv is a display object that serves as a virtual representation of the user U. For example, the virtual user Uv may be an avatar (human character) that plays the virtual wind instrument Mv. The virtual user Uv has a head, torso, and arms. Similarly, the virtual wind instrument Mv is a display object that serves as a virtual representation of the wind instrument M. The virtual wind instrument Mv represents the form of the wind instrument M, and is disposed in the virtual space.

In the virtual playing video V, playing of the virtual wind instrument Mv by the virtual user Uv is controlled to be synchronized with playing of the wind instrument M by the user U. That is, the virtual user Uv in the virtual space carries out the same playing operations as those carried out by the user U in playing the wind instrument M.

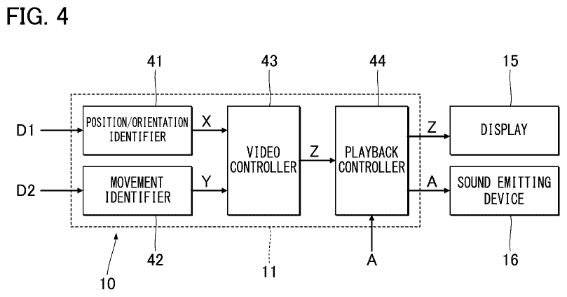

FIG. 4 is a block diagram of the information processing system 10. The controller 11 executes a program stored in the storage device 12 to implement functions, such as a position/orientation identifier (hereinafter, “position identifier”) 41, a movement identifier 42, a video controller 43, and a playback controller 44 to generate video data Z.

The position identifier 41 identifies a position and orientation X of the wind instrument M from the first detection signal D1. A technique such as use of a Madgwick filter may be used to analyze the first detection signal D1. The position and orientation X are defined by positions along each of the three orthogonal axes and rotation angles (yaw angle, pitch angle, and roll angle) about each axis.

The movement identifier 42 identifies a movement Y of the user U from the second detection signal D2. Specifically, the movement identifier 42 identifies whether the following actions are performed: blowing into the mouthpiece 21 and operating the keys 25 of the wind instrument M.

The video controller 43 generates video data Z representative of the virtual playing video V. To generate the video data Z, the following data is stored in the storage device 12: display data and control data for the virtual user Uv, and display data for the virtual wind instrument Mv. The display data for the virtual user Uv is model data representative of the three-dimensional appearance of the virtual user Uv and of the skeleton of the virtual user Uv. The control data for the virtual user Uv is movement data that defines a movement of the virtual user Uv. The display data for the virtual wind instrument Mv is model data that represents the three-dimensional appearance of the virtual wind instrument Mv.

The video controller 43 generates video data Z by use of the following processes: arranging the virtual user Uv and the virtual wind instrument Mv in the virtual space based on their respective display data; operating the virtual user Uv based on the control data; and rendering the virtual user Uv and the virtual wind instrument Mv by using a virtual camera disposed in the virtual space. The video data Z is generated by the video controller 43 while the user U plays the wind instrument M. The generated video data Z is stored in the storage device 12. The format of the video data Z can be freely selected.

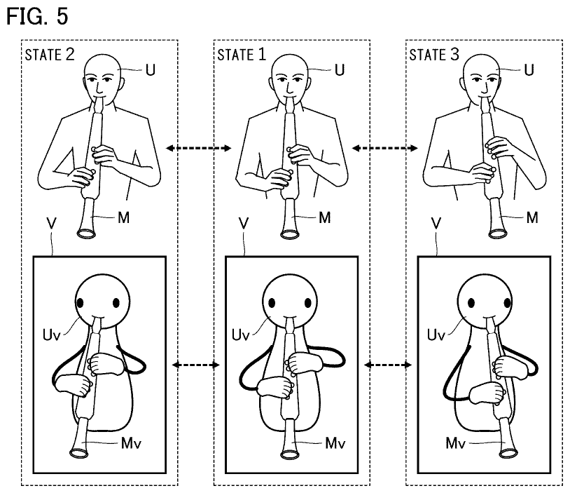

In generating the video data Z (the virtual playing video V), the video controller 43 controls a position and orientation of the virtual wind instrument Mv in correspondence with the position and orientation X of wind instrument M, as identified by the position identifier 41. The video controller 43 also controls a movement of the virtual user Uv in correspondence with the movement Y of the user U, as identified by the movement identifier 42. FIG. 5 shows a relationship between the user U and the wind instrument M, and the virtual user Uv and the virtual wind instrument Mv.

The video controller 43 controls the virtual wind instrument Mv in the virtual space such that the virtual wind instrument Mv has the same position and orientation as the position and orientation X of the wind instrument M. Further, the video controller 43 controls the virtual user Uv in the virtual space such that the virtual user Uv makes the same movement as the movement Y made by the user U.

As shown in state 1 in FIG. 5, the wind instrument M is played by the user U in a forward-facing position. In state 2, when the user U tilts the wind instrument M to the right from the state 1, the virtual user Uv likewise tilts the virtual wind instrument Mv to the right and simultaneously tilts the virtual body to the right. Similarly, in state 3, when the user U tilts the wind instrument M to the left from the state 1, the virtual user Uv likewise tilts the virtual wind instrument Mv to the left and simultaneously tilts the virtual body to the left.

For example, when the user U blows into the mouthpiece 21, the video controller 43 controls the virtual user Uv such that the virtual user Uv blows into the mouthpiece 21 of the virtual wind instrument Mv. When the user U operates any one of the keys 25, the video controller 43 controls an angle or shape of the fingers of the virtual user Uv such that the virtual user Uv operates any corresponding one of the keys 25 of the virtual wind instrument Mv.

In the first embodiment, the video controller 43 controls the movement of the virtual user Uv in synchronization with the position and orientation of the virtual wind instrument Mv. Specifically, the video controller 43 controls the position and orientation of the virtual user Uv in synchronization with changes in the position and orientation of the virtual wind instrument Mv. In one example, when the user U plays the wind instrument M and simultaneously tilts their body (the head, torso, and arms), the position and orientation X of the wind instrument M change over time in conjunction with the movement of the user U. As shown in FIG. 5, the video controller 43 tilts the virtual user Uv (e.g., the head, torso, and arms) such that the position and orientation of the virtual wind instrument Mv correspond with the position and orientation X of the wind instrument M.

The video controller 43 controls the movement of the virtual user Uv such that the head (in particular, the mouth) of the virtual user Uv remains aligned with the mouthpiece 21 of the virtual wind instrument Mv, and the fingers remain aligned with keys of the virtual wind instrument Mv. For example, Forward Kinematics or Inverse Kinematics may be used to control the position and orientation of the virtual wind instrument Mv and the movement of the virtual user Uv.

As shown in FIG. 4, the playback controller 44 plays back the video data Z (the virtual playing video V). Specifically, the playback controller 44 transmits the video data Z to the display 15, whereby the virtual playing video V is displayed on the display 15. Further, the playback controller 44 controls the sound emitting device 16 to emit sound represented by the audio signal A in conjunction with the display of the virtual playing video V. Thus, the viewer can observe how the virtual user Uv plays the virtual wind instrument Mv.

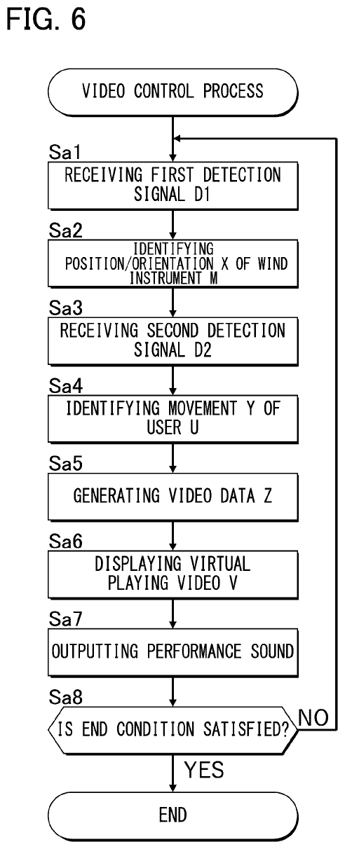

FIG. 6 is a flowchart of a video control process, which illustrates how video data Z is generated by the information processing system 10. In this example, the video control process begins when the user U operates the input device 14.

When the video control process begins, the controller 11 (the position identifier 41) receives a first detection signal D1 from the wind instrument M via the communication device 13 (Sa1), and identifies a position and orientation X of the wind instrument M based on the first detection signal D1 (Sa2). Further, the controller 11 (the movement identifier 42) receives a second detection signal D2 from the wind instrument M via the communication device 13 (Sa3), and identifies a movement Y of the user U based on the second detection signal D2 (Sa4). The steps Sa1 and Sa2 for identifying the position and orientation X of wind instrument M can be performed after the steps Sa3 and Sa4 for identifying, the movement Y of the user U.

The controller 11 (the video controller 43) generates video data Z (virtual playing video V) that represents the virtual wind instrument Mv in the position and orientation X and the virtual user Uv with the movement Y (Sa5). The controller 11 (the playback controller 44) displays the video data Z (virtual playing video V) on the display 15 (Sa6), and plays back the video data Z to emit sound from the sound emitting device 16 represented by the audio signal A (Sa7).

The controller 11 determines whether an end condition is satisfied (Sa8). The end condition is satisfied when a user's instruction to end the video control process is received by the controller 11 via the input device 14. When the end condition is not satisfied (Sa8: NO), the controller 11 returns the process to step Sa1. Thus, the following steps are repeated until the end condition is satisfied: steps Sa1 and Sa2 for identifying the position and orientation X of the wind instrument M, steps Sa3 and Sa4 for identifying the movement Y of the user U, step Sa5 for generating the video data Z, and steps Sa6 and Sa7 for playing back the virtual playing video V and outputting the audio signal A. When the end condition is satisfied (Sa8: YES), the controller 11 ends the video control process.

As described above, in the first embodiment, the position and orientation of the virtual wind instrument Mv are controlled based on the identified position and orientation X of the wind instrument M, and the movement of the virtual user Uv is controlled based on the identified movement of the user U. As a result of the control, the virtual playing video V, which represents the virtual user Uv playing the virtual wind instrument Mv, accurately mirrors the movement of the user U playing the wind instrument M. In particular, the movement of the virtual user Uv is synchronized with the position and orientation of the virtual wind instrument Mv, thereby generating video data that naturally represents the user U playing the wind instrument M.

In the first embodiment, the first sensor 31 and the second sensor 32 are both mounted to the wind instrument M to detect playing by the user U. As a result, the user U is not required to wear on their body a sensor to detect the movement Y.

Other methods for detecting the position and orientation X of the wind instrument M and the movement Y of the user U involve analyzing a video of a scene captured by a camera in which the user U is playing the wind instrument M. However, in the first embodiment, since the first sensor 31 and the second sensor 32, are both mounted to the wind instrument M, there is no need to install a camera to analyze captured video to detect the playing of the wind instrument M.

It is note of that the scope of this disclosure may include the following configurations of the video control system: identifying the position and orientation X of the wind instrument M and the movement Y of the user U based on the output from a sensor worn by the user U; and identifying the position and orientation X of the wind instrument M and the movement Y of the user U based on video of the user U captured by the camera.

### B: Second Embodiment

A second embodiment will now be described. In each of the embodiments described below, like reference signs are used for elements having functions or effects that are the same as those of elements described in the first embodiment, and detailed explanations of such elements are omitted as appropriate.

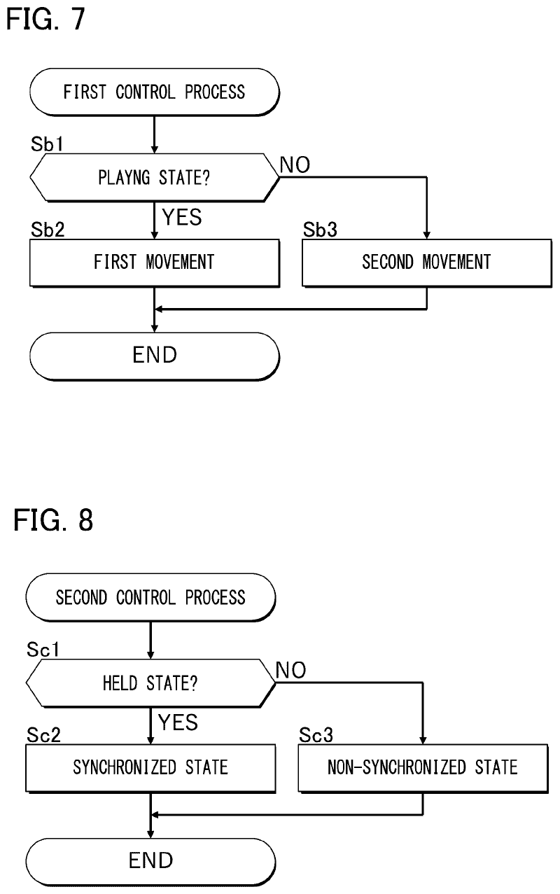

FIG. 7 is a flowchart of a first control process according to the second embodiment, which is executed during the video control process by the controller 11. The first control process is executed at step Sa5, in which the video data Z is generated during the video control process.

When the first control process begins, the controller 11 (the video controller 43) determines whether the user U is playing the wind instrument M (Sb1). Here, two scenarios are considered: one in which the user U is playing the wind instrument M (hereinafter, “playing state”), and the other in which the user U is holding but not playing the wind instrument M (hereinafter, “standby state”). The playing state refers to a state in which the user U blows into the mouthpiece 21 and simultaneously operates the operation section 24. The standby state refers to a state in which the user U either waits to play the wind instrument M or moves (carries) but does not play the wind instrument M.

Specifically, the controller 11 determines whether the user U is in the playing state by analyzing at least one of the first detection signal D1 and the second detection signal D2. In one example of the playing state, the user U may tilt the wind instrument M in a pattern. In this case, when a temporal change in the position and orientation X of the wind instrument M, as represented by the first detection signal D1, approximates or matches a pattern that is highly likely to occur in the playing state, the controller 11 determines that the user U is in the playing state.

In the playing state, the user U blows into the mouthpiece 21 and simultaneously operates the operation section 24. Accordingly, the controller 11 determines whether an air pressure produced by blowing into the mouthpiece 21, as represented by the second detection signal D2, exceeds a threshold. When the air pressure exceeds the threshold, the controller 11 determines that the user U is in the playing state. Otherwise, the controller 11 determines that the user U is in the standby state.

Further, the controller 11 determines whether the second detection signal D2 detects that the operation section 24 is operated. When the operation section 24 is operated, the controller 11 determines that the user U is in the playing state. Otherwise, the controller 11 determines that the user U is in the standby state.

When the controller 11 determines that the user U is in the playing state (Sb1: YES), the controller 11 (the video controller 43) controls the virtual user Uv to perform a first movement (first task) (Sb2). Otherwise (Sb1: NO), the controller 11 controls the virtual user Uv to perform a second movement (second task) that differs from the first movement (Sb3).

As in the first embodiment, the first movement is defined as the virtual user Uv playing the virtual wind instrument Mv. The controller 11 controls the virtual user Uv to carry out the movement Y of the user U and adjusts the virtual wind instrument Mv to the position and orientation X of the wind instrument M. Thus, in the first movement, the movement of the virtual user Uv is synchronized with the position and orientation of the virtual wind instrument Mv.

The second movement is defined as the virtual user Uv holding but not playing the virtual wind instrument Mv. The controller 11 holds the virtual user Uv still with the mouth (head) of the virtual user Uv positioned away from the mouthpiece 21 of the virtual wind instrument Mv. Thus, in the second movement, the movement of the virtual user Uv is not synchronized with the position and orientation of the virtual wind instrument Mv.

Steps performed in the video control other than the first control process are the same as those performed in the first embodiment. Accordingly, the second embodiment provides the same effects as those of the first embodiment. Further, in the second embodiment, the virtual user Uv carries out either the first movement or the second movement based on whether the user U is in the playing state. As a result, it is possible to replicate, in the virtual user Uv and the virtual wind instrument Mv, real-world tendencies in which two distinct types of movement differ: a movement of the user U in the playing state (e.g., tilting while holding the wind instrument M); and a movement of the user in the standby state (e.g., waiting to play the wind instrument M or moving (carrying) but not playing the instrument M).

In particular, the virtual user Uv can play as well as hold the virtual wind instrument Mv. Thus, the virtual user Uv can carry out the same natural movements as those carried out by the user U in playing the wind instrument M.

In the second embodiment, the controller 11 determines whether the user U is in the playing state by analyzing at least one of the first detection signal D1 and the second detection signal D2. That is, the first detection signal D1 or the second detection signal D2 is used for the following: identifying either the position and orientation X of the wind instrument M or the movement Y of the user U, and determining whether the user U is in the playing state. As a result, the processing load required to control the virtual user Uv and the virtual wind instrument Mv can be reduced as compared to when no detection signals (D1 and D2) are used to assess the playing state.

### C: Third Embodiment

FIG. 8 is a flowchart of a second control process according to the third embodiment, which is executed by the controller 11 during the video control process. The second control process is executed at step Sa5, in which the video data Z is generated during the video control process.

When the second control process begins, the controller 11 (the video controller 43) determines whether the wind instrument M is being held by the user U (Sc1). Here, two scenarios are considered: one in which the wind instrument M is being held by the user U (hereinafter, “held state”), and the other in which the wind instrument M is not being held (hereinafter, “non-held state”). The held state includes both the playing state and the standby state, described in the second embodiment. The non-holding state refers to a condition in which the wind instrument M is located apart from the body of user U and remains stationary.

Specifically, the controller 11 determines whether the wind instrument M is in the held state by analyzing at least one of the first detection signal D1 and the second detection signal D2. First, the controller 11 determines whether the position and orientation X of the wind instrument M, as identified based on the first detection signal D1, change over time. When the position and orientation X change over time, the controller 11 determines that the wind instrument M is in the held state. If the position and orientation X do not change over time, the controller 11 determines that the wind instrument M is in the non-held state. Second, the controller 11 determines whether an angle of the position and orientation X of the wind instrument M, as identified based on the first detection signal D1, falls within a predetermined range. When the angle of the position and orientation X falls within the predetermined range (e.g., the angle is approximately horizontal), the controller 11 determines that the wind instrument M is in the non-held state. Third, the controller 11 determines whether the user U is in the playing state by analyzing the second detection signal D2. When the user U is determined to be in the playing state, the controller 11 determines that the wind instrument M is in the held state. The determination of whether the user U is in the playing state is the same as the determination in the second embodiment.

As in the first embodiment, when the controller 11 determines that the wind instrument M is in the held state (Sc1: YES), the controller 11 (the video controller 43) controls the movement of the virtual user Uv in synchronization with the position and orientation of the virtual wind instrument Mv (Sc2). Specifically, the controller 11 controls the position and orientation of the virtual user Uv in synchronization with changes in the position and orientation of the virtual wind instrument Mv.

In contrast, when the controller 11 determines that the wind instrument M is in a non-held state (Sc1: NO), the controller 11 controls the movement of the virtual user Uv independently of the position and orientation of the virtual wind instrument Mv (Sc3). The virtual wind instrument Mv remains stationary, and the virtual user Uv is in the standby state.

Steps carried out in the video control process other than the second control process are the same as those carried out in the first embodiment. Accordingly, the third embodiment provides the same effects as the first embodiment. Furthermore, in the third embodiment, the movement of the virtual user Uv and the position and orientation of the virtual wind instrument Mv are switched between a synchronized state and a non-synchronized state, based on whether the wind instrument M is in the held state. As a result, real-world tendencies can be replicated in the virtual user Uv and the virtual wind instrument Mv, such as when movement of the wind instrument M is synchronized with the movement of the user U when the wind instrument M in the held state, but otherwise remains independent of the movement of the user U.

In particular, the controller 11 determines whether the wind instrument M is in the held state by analyzing at least one of the first detection signal D1 and the second detection signal D2. That is, the detection signals are used as follows: identifying either the position and orientation X of the wind instrument M or the movement Y of the user U, and determining whether the wind instrument M is in the held state. As a result, the processing load required to control the virtual user Uv and the virtual wind instrument Mv can be minimized as compared to when no detection signals (D1 and D2) are used to determine whether the real wind instrument M is the held state.

### D: Fourth Embodiment

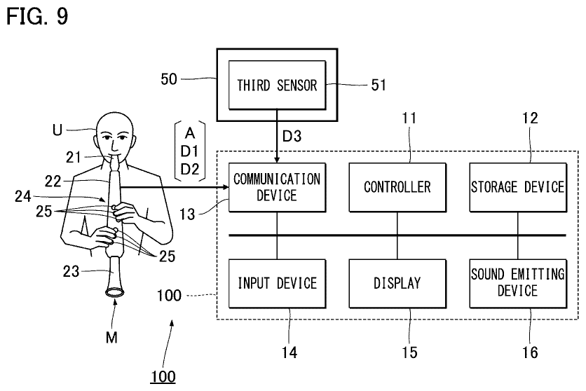

FIG. 9 is a block diagram of the video control system 100 according to the fourth embodiment. In the fourth embodiment, the video control system 100 includes a support structure 50 in addition to the wind instrument M and the information processing system 10. The support structure 50 supports the wind instrument M when it is not being played by the user U. The support structure 50 may be a wind instrument stand or a storage case.

The support structure 50 includes a third sensor 51 that detects whether the wind instrument M is supported by the support structure 50. Examples of the third sensor 51 include an optical sensor that detects a presence of the wind instrument M using light, and a mechanical sensor (e.g., a switch) that outputs a signal indicating placement of the wind instrument M. The third sensor 51 generates a third detection signal D3 representative of whether the wind instrument M is placed within the support structure 50. The third detection signal D3 generated by the third sensor 51 is transmitted to the information processing system 10. The communication device 13 receives the third detection signal D3 from the support structure 50.

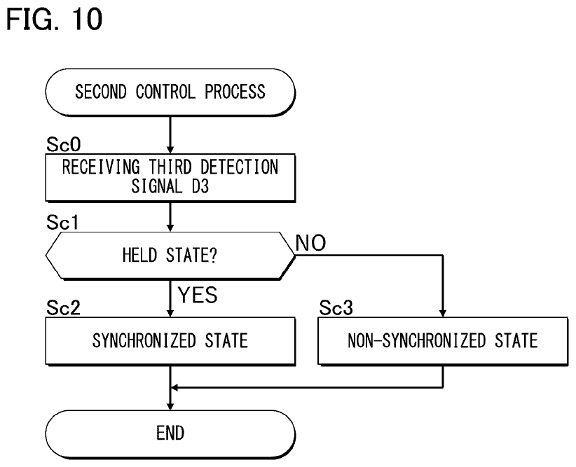

FIG. 10 is a flowchart of second control process according to the fourth embodiment. The second control process (see FIG. 10) is carried out at step Sa5 as described in the third embodiment (see FIG. 6), in which video data Z is generated during the video control process. When the second control process begins, the controller 11 (the video controller 43) receives third detection signal D3 from the support structure 50 via the communication device 13 (Sc0).

In the third embodiment, the controller 11 determines whether the wind instrument M is in the held state by analyzing either the first detection signal D1 or the second detection signal D2. In contrast, in the fourth embodiment, the controller 11 (the video controller 43) determines whether the wind instrument M is in the held state by analyzing the third detection signal D3 (Sc1). Specifically, when the third detection signal D3 represents that the wind instrument M is supported by the support structure 50, the controller 11 determines that the wind instrument M is in the non-held state. Otherwise, the controller 11 determines that the wind instrument M is in the held state.

When the wind instrument M is the held state (Sc1: YES), the controller 11 controls the movement of the virtual user Uv in synchronization with the position and orientation of the virtual wind instrument Mv (Sc2). Otherwise (Sc1: NO), the controller 11 controls the movement of the virtual user Uv independently of the position and orientation of the virtual wind instrument Mv (Sc3). Thus, the fourth embodiment provides the same effects as those provided in the third embodiment.

In the fourth embodiment, the controller 11 determines whether the wind instrument M is in the held state by analyzing the third detection signal D3, which is generated by the third sensor 51 mounted to the support structure 50 for the wind instrument M. As a result, it is possible to accurately determine whether the wind instrument M is in the held state, as compared to when the first detection signal D1 or the second detection signal D2 is used for determination.

In the foregoing second embodiment, the controller 11 determines whether the wind instrument M is in the held state by analyzing at least one of the first detection signal D1 and the second detection signal D2. As will be clear from this description, it is not essential to use either the first detection signal D1 or the second detection signal D2 in determining whether the wind instrument M is in the held state.

### E: Fifth Embodiment

An error component (drift component) may be associated with the position and orientation X of the wind instrument M, as determined by analysis of the first detection signal D1. The error component can accumulate over time due to various factors, such as detection errors in the first sensor 31 (particularly the gyroscope 312), computational errors in the analysis of the first detection signal D1 (e.g., integration errors when calculating an angle from an angular velocity), and measurement errors caused by temporary or time-dependent deformation of the first sensor 31. To address the error component, in the fifth embodiment, the controller 11 (position identifier 41) performs a correction that reduces the error component associated with the position and orientation X of the wind instrument M.

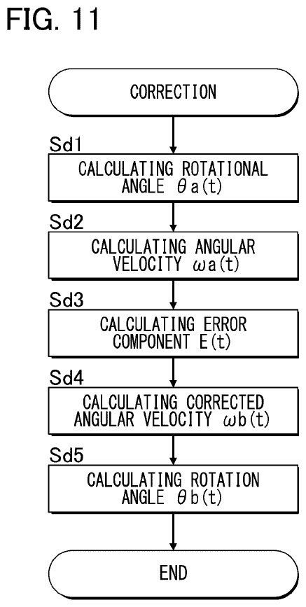

FIG. 11 is a correction flowchart according to the fifth embodiment, the correction being performed by the controller 11. The correction as shown in FIG. 11 is performed at step Sa2 during the video control process, in which the position and orientation X of wind instrument M are identified based on the first detection signal D1. Thus, at step Sa2 the identified position and orientation X of the wind instrument M includes the correction to reduce the error component.

When the correction begins, the controller 11 (the position identifier 41) calculates a rotational angle θa(t) by analyzing the first detection signal D1 (Sd1). The rotation angle θa(t) is a measured value derived from the angular velocity of the wind instrument M in the yaw direction, as detected by the gyroscope 312 of the first sensor 31. Here, the symbol t represents a specific point in time along the time axis.

The controller 11 calculates an angular velocity ωa(t) by obtaining a difference, expressed as (θa(t)−θa(t−1)), between the current rotation angle θa(t) and an immediately preceding rotation angle θa(t−1) (Sd2). The angular velocity ωa(t) corresponds to the rotation of the wind instrument M in the yaw direction. When angular velocity ωa(t) is directly derived from analysis of the first detection signal D1, steps Sd1 and Sd2 at which an angular velocity ωa(t) is calculated based on the rotation angle θa(t), may be omitted.

When playing the wind instrument M, the user U may repeat tilting of the wind instrument M in the leftward and rightward (yaw direction). In this case, the average angular velocity ωa(t) over a sufficiently long time period relative to the swing cycle of the wind instrument M, approaches zero, provided that ωa(t) is free from an error component. Accordingly, any deviation of the average angular velocity ωa(t) over a time interval corresponds to an error component associated with ωa(t). In view of the above circumstances, the controller 11 calculates an error component E(t) by averaging the angular velocities ωa(t) over a specified number of past time points (Sd3). In the fifth embodiment, the error component E(t) is exemplified as being calculated at each time point t; however, it may alternatively be computed at intervals corresponding to a predetermined period that is longer than the time step t.

The controller 11 calculates a corrected angular velocity ωb(t) by subtracting the error component E(t) from the current angular velocity ωa(t) (Sd4). The controller 11 then calculates a rotation angle θb(t) by integrating the corrected angular velocity ωb(t) (Sd5). The rotation angle θb(t) represents the yaw-direction angle of the wind instrument M. As described above, in the fifth embodiment, the correction includes subtracting, from each measured angular velocity ωa(t) on the time axis, an average of the angular velocities ωa(t) related to the position and orientation X of the wind instrument M, with the angular velocities identified based on the first detection signal D1. The corrected rotational angle θb(t) is applied at step Sa5 to generate the video data Z as the position and orientation X of the wind instrument M.

The fifth embodiment provides the same effects as those provided in the first embodiment. In the fifth embodiment, the error component E(t) that accumulates in the identified position and orientation X of the wind instrument M is reduced, and thus the virtual wind instrument Mv is able to accurately replicate the position and orientation X of the wind instrument M. In particular, the error component E(t) can be effectively minimized by correction, taking into account a tendency that an average of the measured values (angular velocity ωa(t)) related to the position and orientation X of the wind instrument M aligns with the error component E(t). An additional benefit is realized in that a need for a dedicated correction sensor, such as a geomagnetic sensor, is eliminated since the measured angular velocity ωa(t) from the first sensor 31 is used for the correction.

### F: Modifications

Examples of modifications that can be made to the foregoing embodiments will now be described. Two or more aspects freely selected from the following examples may be combined in so far as they do not contradict each other.
(1) In the second embodiment, the controller 11 determines whether the user U is in the playing state by analyzing at least one of the first detection signal D1 and the second detection signal D2. However, a method used for this determination is not limited thereto. For example, when a volume of the playing sound represented by the audio signal A exceeds a predetermined threshold, the controller 11 may determine that the user U is in the playing state. Alternatively, the controller 11 may determine that the user U is in the playing state based on an output from a sensor other than the first sensor 31 and the second sensor 32.
(2) The configuration and targets of the first sensor 31 and the second sensor 32 are not limited to the foregoing. For example, the second sensor 32 may include an embouchure sensor that detects an embouchure of the user U. The embouchure sensor may be installed at the lead or mouthpiece 21 of the wind instrument M. The detection result from any of the first sensor 31 or the second sensor 32 can be applied to the video control process, which includes identification of the position and orientation X of the wind instrument M, identification of the movement Y of the user U, determination of whether the user U is in the playing state, and determination of whether the wind instrument M is in the held state.

In the foregoing embodiments, the second sensor 32 includes the operation sensor 322 that determines a user's input to the keys 25 of the wind instrument M. However, the operation sensor 322 may detect manipulation amount of the keys 25, such as a displacement amount of the keys 25. The controller 11 adjusts angles or shapes of the fingers of the virtual user Uv corresponding to respective ones of the keys 25 based on manipulation amounts of the respective ones of the keys 25.
(3) In the foregoing embodiments, the position and orientation X of the wind instrument M are identified by analyzing the first detection signal D1 generated by the first sensor 31. The movement Y of the user U is identified by analyzing the second detection signal D2 generated by the second sensor 32. However, a relationship between (i) the first detection signal D1 and the second detection signal D2, and, (ii) the specification target of the controller 11, is not limited to this example. For example, the controller 11 may use the first detection signal D1 to identify both the position and orientation X of the wind instrument M and the movement Y of the user U. Alternatively, the controller 11 may use the second detection signal D2 for the same purpose.
(4) In the foregoing embodiments, the audio signal A is generated by the sound source device 33 of the wind instrument M and reproduced. However, the method used for this generation and reproduction is not limited thereto. For example, the information processing system 10 may include a sound receiver (a microphone) that receives a playing sound from the sound emitting device 34 of the wind instrument M. In such a configuration, an audio signal A generated by the sound emitting device 34 may be reproduced together with a virtual playing video V. Alternatively, the information processing system 10 may receive from the wind instrument M, time-series data, such as MIDI data, representative of playing of the wind instrument M. In such a configuration, the controller 11 (sound source circuitry) of the information processing system 10 may generate an audio signal A based on the time-series data.
(5) The musical instrument played by the user U is not limited to the wind instrument M. For example, the foregoing embodiments are applicable to a variety of musical instruments, such as a keyboard musical instrument, a stringed musical instrument, and a percussion musical instrument. However, since a position and orientation X of the musical instrument are identified based on changes in the position and orientation, a typical example of the musical instrument in this disclosure is a portable musical instrument in which the position and orientation X change in synchronization with playing of the musical instrument by the user U. The first sensor 31 may be mounted to the musical instrument to detect the position and orientation X of the musical instrument, and the second sensor 32 detects the movement Y of the user U.

Specifically, for a keyboard musical instrument such as a portable shoulder-supported keyboard musical instrument, the first sensor 31 may be mounted to the keyboard musical instrument to detect a position and orientation X of the keyboard musical instrument. The second sensor 32 may detect a manipulation of each key, including, for example, a key depression velocity, or a key depression amount. For a stringed musical instrument, the first sensor 31 may be mounted to the stringed musical instrument to detect a position and orientation X of the stringed musical instrument. The second sensor 32 may detect a movement Y, such as pressing, plucking or bowing of each string of the stringed musical instrument. For a percussion instrument, the first sensor 31 may be mounted to the percussion instrument to detect a position and orientation X of the percussion instrument. The second sensor 32 may detect a striking action, such as a presence or intensity of a strike.
(6) A method of the correction to reduce the error component E(t) related to the position and orientation X of the wind instrument M is not limited to the examples of the fifth embodiment. For example, the controller 11 (the position identifier 41) may perform a numerical operation to reduce the error component E(t) toward zero at predetermined intervals (e.g., at each time point t).
(7) In the foregoing embodiments, the video controller 43 generates video data Z, which represents a virtual playing video V. However, instead of the video data Z, control data may be used that represents a position and orientation of the virtual wind instrument Mv and a movement of the virtual user Uv. Specifically, the control data may be movement data representative of a temporal change in the position and orientation of the virtual wind instrument Mv and a temporal change in the movement of the virtual user Uv. Alternatively, the control data may include a time series of control values for the position and orientation of the virtual wind instrument Mv and a time series of control values for the movement of the virtual user Uv.

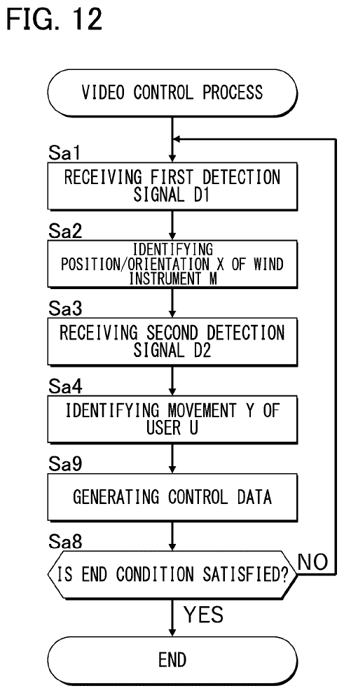

FIG. 12 is a flowchart of video control process according to this modification. Steps Sa1 and Sa2 at which a position and orientation X are identified of the wind instrument M, and steps Sa3 and Sa4 at which a movement Y is identified of the user U, are the same as those of the foregoing embodiments. The controller 11 (the video controller 43) generates control data, which represents as follows: a change in the position and orientation of the virtual wind instrument Mv in accordance with the position and orientation X of the wind instrument M, and a change in the movement of the virtual user Uv in accordance with the movement Y of the user U (Sa9). By this step, the position and orientation X of the wind instrument M and the movement Y of the user U are incorporated in the control data. The method for controlling both elements in generating the control data, namely, for controlling the position and orientation of the virtual wind instrument Mv and the movement of the virtual user Uv, is the same as that described in the foregoing embodiments. The control data generated by the video controller 43 may be stored in the storage device 12. During the video control process, steps Sa1 and Sa2, at which a position and orientation X of the wind instrument M are determined, steps Sa3 and Sa4, at which a movement Y is determined of the user U, and steps Sa9, at which control data is generated, are repeated until the end condition is satisfied (Sa8: YES). The controller 11 (the playback controller 44) displays video data Z (the virtual playing video V) on the display 15 based on the control data. Similarly, to the foregoing embodiments, the position and orientation of the virtual wind instrument Mv are controlled based on the position and orientation X of the wind instrument M, and the movement of the virtual user Uv is controlled based on the movement Y of the user U.

The controller 11 (the moving image control unit 43) may edit the control data generated by the video control process. The control data may be edited by the controller 11 in response to a user input via the input device 14. The controller 11 may edit the control data to incorporate a movement identified by the input device 14 into the position and orientation of the virtual wind instrument Mv or the movement of the virtual user Uv, as represented by the control data. Further, the controller 11 may update the position and orientation of the virtual wind instrument Mv or the movement of the virtual user Uv based on the user input received through the input device 14.

As will be clear from the foregoing description, the video controller 43 generates a virtual playing video V that represents the virtual user Uv and the virtual wind instrument Mv. Comprehensively described, the video controller is an element that controls a position and orientation of the virtual wind instrument Mv based on the identified position and orientation X of the wind instrument M, and controls a movement of the virtual user Uv based on the identified movement Y of the user U. A method in which the result of the control described above can be freely selected in this disclosure. The generation of the video data and the generation of the control data are examples of a method in which the control result is used.
(8) The scope of this disclosure is not limited to a scenario in which a musical instrument is used. For example, the foregoing embodiments may be applied to a variety of different devices. Examples of a device that can be used in the real world by the user U include an information device, such as a smartphone or a computer tablet, a work tool, and an electronic appliance. The first sensor 31 may be installed in any such device to generate a first detection signal D1 corresponding to the position and orientation X of the device. The second sensor 32 detects a movement Y of the user U who uses the device.
(9) The foregoing information processing system 10 may be realized by a server device that communicates with an information device, such as a smartphone or a computer tablet. The information processing system 10 may receive an audio signal A, a first detection signal D1, and a second detection signal D2 from the information device via a network. The information processing system 10 may also receive, from the information device, a third detection signal D3 described in the third embodiment. The information processing system 10 may also generate video data Z in the same manner as in the foregoing embodiments, and transmit the generated video data Z to the information device. The video data Z is received from the information processing system 10 and is played back by the information device. Accordingly, the playback controller 44 may be omitted from the information processing system 10. The video data Z may be transmitted to a video distribution system, or may be stored therein. The video data Z is then distributed to a large number of information devices by the video distribution system.

When the position identifier 41 is included in the information device, the position identifier 41 may be omitted from the information processing system 10. In this case, the information processing system 10 may receive a position and orientation X of the wind instrument M from the information device. Similarly, when the movement identifier 42 is included in the information device, the movement identifier 42 may be omitted from the information processing system 10. In this case, the information processing system 10 may receive a movement Y of the user U from the information device.

The information processing system 10 as shown in FIG. 12, which generates control data by the video control process, may be realized by a server device that communicates with the information device. For example, the generated control data (or the control data edited after generation) may be transmitted to an information device. The information device may display a virtual playing video V that represents playing of the virtual wind instrument Mv by the virtual user Uv, using the control data received from the information processing system 10. Similarly, to the foregoing embodiments, the position and orientation of the virtual wind instrument Mv are controlled based on the position and orientation X of the wind instrument M, and the movement of the virtual user Uv is controlled based on the movement Y of the user U.
(10) The functions of the information processing system 10 are implemented by cooperation of one or more processors of the controller 11 and a program stored in the storage device 12. The program according to this disclosure may be provided in a form stored in a computer-readable recording medium and be installed in the computer. The recording medium may be a non-transitory recording medium, examples of which include an optical recording medium (optical disk), such as a CD-ROM, a semiconductor recording medium, and a magnetic recording medium. The non-transitory recording medium includes any recording medium except for a transitory propagating signal, and a volatile recording medium is not excluded. Further, when the program is distributed by a distribution device via a network, the storage medium storing the program in the distribution device corresponds to the non-transitory recording medium.

### G: Appendices

The following configurations are derivable from the foregoing embodiments.
A computer-implemented method for processing information, according to an example (Aspect 1) of this disclosure, includes: identifying a position and orientation of a musical instrument based on a first detection signal output from a first sensor mounted to the musical instrument, the musical instrument being a real musical instrument used by a real user; identifying a movement of the real user based on a second detection signal output from a second sensor that detects the movement of the real user relative to the real musical instrument; controlling, based on the identified position and orientation of the real musical instrument, a position and orientation of a virtual musical instrument used by a virtual user, as represented by video data; and controlling, based on the identified movement of the real user, a movement of the virtual user.

In this aspect, the position and orientation of the virtual musical instrument are controlled based on the identified position and orientation of the real musical instrument. Similarly, the movement of the virtual user is controlled based on the identified movement of the real user. This control accurately replicates the movement of the real user playing the real musical instrument in video data representative of the movement of the virtual user playing the virtual musical instrument.
In an example (Aspect 2) according to Aspect 1, the controlling both the position and orientation of the virtual musical instrument and the movement of the virtual user includes synchronizing the position and orientation of the virtual musical instrument with the movement of the virtual user.

In this aspect, the movement of the virtual user is synchronized with the position and orientation of the virtual musical instrument, thereby generating a natural video data representative of the real-user playing the real wind instrument.

Here, the movement of the virtual user may be controlled based on the identified movement of the real user and may be synchronized with the position and orientation of the virtual musical instrument, which is based on the identified position and orientation of the real musical instrument. Conversely, the position and orientation of the virtual musical instrument may be controlled based on the identified position and orientation of the real musical instrument and may be synchronized with the movement of the virtual user, which is based on the identified movement of the real user.
In an example (Aspect 3) according to Aspect 1 or 2, the controlling the movement of the virtual user includes: determining whether the real user is playing the real musical instrument, causing the virtual user to carry out a first movement based on a determination that the real user is playing the real musical instrument, and causing the virtual user to carry out a second movement based on a determination that the real user is not playing the real musical instrument.

In this aspect, the virtual user performs the first or second movement based on whether the real user is playing the musical instrument. This makes it possible to accurately replicate, in the virtual user and the virtual musical instrument, real-world tendencies in which two distinct types of movement differ: a movement of the real user who is playing the real musical instrument (e.g., tilting); and a movement of the real user who is not playing the musical instrument (e.g., is waiting to play the real musical instrument or carrying the real musical instrument).
In an example (Aspect 4) according to Aspect 3, the first movement is defined as a movement carried out by the virtual user in playing the virtual musical instrument, and the second movement is defined as a movement carried out by the virtual user in holding but not playing the virtual musical instrument.

According to this aspect, the virtual user holds the virtual musical instrument prior to playing the virtual musical instrument. The virtual user carries out the same natural movements as those carried out by the real user in playing the real wind instrument.
In an example (Aspect 5) according to Aspect 3 or 4, the determining analyzes at least one of the first detection signal and the second detection signal, to determine whether the real user is playing the real musical instrument.

According to this aspect, at least one of the first detection signal and the second detection signal is used as follows: identifying either the position and orientation of the real musical instrument or the movement of the real user, and determining whether the real user is playing the real musical instrument. As a result, the processing load required to control the virtual user and the virtual musical instrument can be reduced as compared to when no detection signals are used to whether the real user is playing the real musical instrument.
In an example (Aspect 6) according to any one of Aspects 1 to 5, the controlling both the position and orientation of the virtual musical instrument and the movement of the virtual user includes: determining whether the real musical instrument is being held by the real user; synchronizing the position and orientation of the virtual musical instrument with the movement of the virtual user based on a determination that the real musical instrument is being held by the real user; and controlling the position and orientation of the virtual musical instrument independently of the movement of the virtual user based on a determination that the real musical instrument is not being held by the real user.

According to this aspect, the movement of the virtual user and the position and orientation of the virtual musical instrument are switched between a coupled state and an independent state, based on whether the real musical instrument is being held. This makes it possible to accurately replicate, in the virtual user and the virtual musical instrument, real-world tendencies in which the movement of the real musical instrument is synchronized with the movement of the real user of the real musical instrument when the real musical instrument is being held, and otherwise the movement of the real musical instrument remains independent of the movement of the user.
In an example (Aspect 7) according to Aspect 6, the determining analyzes at least one of the first detection signal and the second detection signal, to determine whether the real musical instrument is being held by the real user.

According to this aspect, at least one of the first detection signal and the second detection signal is used as follows: identifying either the position and orientation of the real musical instrument or the movement of the real user, and determining whether the real musical instrument is being held. As a result, the processing load required to control the virtual user and the virtual musical instrument can be minimized as compared to when no detection signals are used to determine whether the real musical instrument is being held.
In an example (Aspect 8) according to Aspect 6 or 7, the method further includes receiving a third detection signal output from a third sensor mounted to a support structure that supports the real musical instrument, to determine whether the real musical instrument is being held by the real user.

According to this aspect, the third detection signal is analyzed to determine whether the real musical instrument is being held. This makes it possible to accurately determine whether the real musical instrument is being held, as compared to when the first or second detection signal is used for the determination.
In an example (Aspect 9) according to any of Aspects 1 to 8, the identifying the position and orientation of the real musical instrument includes carrying out a correction that reduces an error component that accumulates in the identified position and orientation of the real musical instrument.

According to this aspect, since the error component (drift) accumulated in the identified position and orientation of the musical instrument is reduced, the virtual musical instrument is able to accurately replicate the position and orientation of the real musical instrument.
In an example (Aspect 10) according to Aspect 9, the correction includes subtracting an average of measured values related to the identified position and orientation of the real musical instrument from each of the measured values on a time axis.

According to this aspect, the error component can be effectively minimized through correction, taking into account a tendency that the average of the measured values related to the position and orientation of the real musical instrument aligns with the error component. An additional benefit is the elimination of the need for a dedicated correction sensor, such as a geomagnetic sensor, since the measured value from the first sensor is used for the correction.
In an example (Aspect 11) according to any one of Aspects 1 to 10, the method further includes generating the video data that incorporates the controlled position and orientation of the virtual musical instrument and the controlled movement of the virtual user.

According to this aspect, video data is generated that represents the virtual user who uses the virtual musical instrument. As a result, the video data can be played back without requiring any additional process, in contrast to when control data is generated that represents the position and orientation of the virtual musical instrument and the movement of the virtual user.
In an example (Aspect 12) according to any one of Aspects 1 to 10, the method further includes generating control data representative of the position and orientation of the virtual musical instrument and the movement of the virtual user.

According to this aspect, the control data enables playback of video data representative of the virtual user who uses the virtual musical instrument. The control data, once edited, can be utilized in the video generation phase.
An information processing system according to an example (Aspect 13) of this disclosure includes: at least one memory that stores programs; and at least one processor that implements the program to: identify a position and orientation of a musical instrument based on a first detection signal output from a first sensor mounted to the musical instrument, the musical instrument being a real musical instrument used by a real user; identify a movement of the real user based on a second detection signal output from a second sensor that detects the movement of the real user relative to the real musical instrument; control, based on the identified position and orientation of the real musical instrument, a position and orientation of a virtual musical instrument used by a virtual user, as represented by video data; and control, based on the identified movement of the real user, a movement of the virtual user.
A non-transitory computer-readable recording medium according to an example (Aspect 14) of this disclosure includes: identifying a position and orientation of a musical instrument based on a first detection signal output from a first sensor mounted to the musical instrument, the musical instrument being a real musical instrument used by a real user; identifying a movement of the real user based on a second detection signal output from a second sensor that detects the movement of the real user relative to the real musical instrument; controlling, based on the identified position and orientation of the real musical instrument, a position and orientation of a virtual musical instrument used by a virtual user, as represented by video data; and controlling, based on the identified movement of the real user, a movement of the virtual user.

### DESCRIPTION OF REFERENCE SIGNS

100 . . . video control system, 10 . . . video control system, 11 . . . controller, 12 . . . storage device, 13 . . . communication device, 14 . . . input device, 15 . . . display, 16 . . . sound emitting device, M . . . wind instrument, 21 . . . mouthpiece, 22 . . . main body, 23 . . . bell, 24 . . . operation section, 25 . . . keys, 31 . . . first sensor, 311 . . . accelerometer, 312 . . . gyroscope, 32 . . . second sensor, 321 . . . breath sensor, 322 . . . operation sensor, 33 . . . sound source device, 34 . . . sound emitting device, 35 . . . communication device, 41 . . . position/orientation identifier, 42 . . . movement identifier, 43 . . . video controller, 44 . . . playback controller, 50 . . . support structure, 51 . . . third sensor.

What is claimed is:

1. A computer-implemented method for processing information, the method comprising:
identifying a position and an orientation of a musical instrument based on a first detection signal output from a first sensor configured to detect the position and the orientation of the musical instrument, the musical instrument being a real musical instrument used by a real user;
identifying a playing operation of the real musical instrument made by the real user based on a second detection signal output from a second sensor that detects the playing operation of the real musical instrument;
controlling, based on the identified position and the identified orientation of the real musical instrument, a position and an orientation of a virtual musical instrument used by a virtual user; and
controlling, based on the identified playing operation of the real musical instrument made by the real user, a playing operation of the virtual musical instrument made by the virtual user.

2. The method according to claim 1, further comprising:
controlling a movement of the virtual user in synchronization with the position and the orientation of the virtual musical instrument.

3. The method according to claim 1, wherein:
the controlling the playing operation of the virtual musical instrument made by the virtual user includes:
determining whether the real user is playing the real musical instrument,
causing the virtual user to perform a first task based on a determination that the real user is playing the real musical instrument, and
causing the virtual user to perform a second task based on a determination that the real user is not playing the real musical instrument.

4. The method according to claim 3, wherein:
causing the virtual user to perform the first task includes causing the virtual user to play the virtual musical instrument, and
causing the virtual user to perform the second task includes causing the virtual user to not play the virtual musical instrument.

5. The method according to claim 3,
wherein determining whether the real user is playing the real musical instrument includes analyzing at least one of the first detection signal and the second detection signal to determine whether the real user is playing the real musical instrument.

6. The method according to claim 1, further comprising:
determining whether the real musical instrument is being held by the real user;
controlling a movement of the virtual user in synchronization with the position and the orientation of the virtual musical instrument based on a determination that the real musical instrument is being held by the real user; and
controlling the movement of the virtual user independently of the position and the orientation of the virtual musical instrument based on a determination that the real musical instrument is not being held by the real user.

7. The method according to claim 6,
wherein determining whether the real musical instrument is being held by the real user includes analyzing at least one of the first detection signal and the second detection signal to determine whether the real musical instrument is being held by the real user.

8. The method according to claim 6, further comprising:
receiving a third detection signal from a third sensor configured to detect whether the real musical instrument is being supported by a support structure that supports the real musical instrument to determine whether the real musical instrument is being held by the real user.

9. The method according to claim 1,
wherein the identifying the position and the orientation of the real musical instrument includes carrying out a correction that reduces an error component that accumulates in the identified position and the identified orientation of the real musical instrument.

10. The method according to claim 9,
wherein the correction includes subtracting an average of a plurality of measured values related to the identified position and the identified orientation of the real musical instrument from each of the plurality of measured values on a time axis.

11. The method according to claim 1, further comprising:
generating video data corresponding to the controlled position of the virtual musical instrument, the controlled orientation of the virtual musical instrument, and the controlled playing operation of the virtual musical instrument made by the virtual user.

12. The method according to claim 1, further comprising:
generating control data corresponding to the position of the virtual musical instrument, the orientation of the virtual musical instrument, and the playing operation of the virtual musical instrument made by the virtual user.

13. The method according to claim 1, wherein the first sensor is mounted to the real musical instrument.

14. An information processing system comprising:
at least one memory that stores a program; and
at least one processor that executes the program to:
identify a position and an orientation of a musical instrument based on a first detection signal output from a first sensor configured to detect the position and the orientation of the musical instrument, the musical instrument being a real musical instrument used by a real user;
identify a playing operation of the real musical instrument made by the real user based on a second detection signal output from a second sensor that detects the playing operation of the real musical instrument;
control, based on the identified position and the identified orientation of the real musical instrument, a position and an orientation of a virtual musical instrument used by a virtual user; and
control, based on the identified playing operation of the real musical instrument made by the real user, a playing operation of the virtual musical instrument made by the virtual user.

15. A non-transitory computer-readable recording medium storing a program executable by at least one processor of a computer to perform a processing information method, the processing information method comprising:
identifying a position and an orientation of a musical instrument based on a first detection signal output from a first sensor configured to detect the position and the orientation of the musical instrument, the musical instrument being a real musical instrument used by a real user;
identifying a playing operation of the real musical instrument made by the real user based on a second detection signal output from a second sensor that detects the playing operation of the real musical instrument;
controlling, based on the identified position and the identified orientation of the real musical instrument, a position and an orientation of a virtual musical instrument used by a virtual user; and
controlling, based on the identified playing operation of the real musical instrument made by the real user, a playing operation of the virtual musical instrument made by the virtual user.
